(19) United States
(12) Patent Application Publication
(10) Pub. No.: US 2008/0029241 A1
(43) Pub. Date: Feb. 7, 2008

(54) Off-road equipment with elevated cooling boxes

(75) Inventor: John M. Bowling, Wooster, OH (US)

Correspondence Address: SAND & SEBOLT, AEGIS TOWER, SUITE 1100, 4940 MUNSON STREET, NW, CANTON, OH, 44718-3615, US

(73) Assignee: RAYCO MANUFACTURING, INC., Wooster, OH (US)

(21) Appl. No.: 11/497,855

(22) Filed: Aug. 1, 2006

(51) Int. Cl. B60H 3/00; F01P 7/10; B60H 1/32

(52) U.S. Cl. 165/42; 62/239; 123/41.48

(57) ABSTRACT

An off-road vehicle includes an engine compartment with an engine disposed therein and a cooling assembly which includes a source of liquid and a cooling location disposed external to the engine compartment for cooling the liquid. One or more heat exchangers is disposed at the cooling location for cooling the liquid, which may include engine coolant, hydraulic fluid or air conditioning coolant. Preferably, the cooling assembly includes a fan which is elevated to minimize the intake of dust and other debris created during operation of the vehicle.

### BACKGROUND OF THE INVENTION

1. Technical Field

The present invention relates generally to off-road equipment. More particularly, the invention relates to a cooling system for such equipment. Specifically, the invention relates to such a cooling system in which the cooling boxes are elevated and disposed externally to the engine compartment of the equipment.

2. Background Information

Off-road equipment in general stirs up more dust and debris than do vehicles which move along paved surfaces. This is especially true when the off-road equipment utilizes a work assembly which engages the earth and thus stirs up a substantial amount of dust. In addition, some off-road equipment utilizes work assemblies which cut or grind various materials, such as wood, into relatively small particles. As is well known in the art, such dust and particulate material are often an impediment to various moving parts of the equipment. For example, engines which power such equipment are often inundated with such dust and particulate material during operation. This is particularly aggravated with relation to cooling systems which draw air into the engine compartment via a fan disposed therein. When such debris collects in the engine compartment, it is difficult to clean and often constitutes a fire hazard. In addition, such debris makes it difficult to maintain cooling of the engine and other components of the equipment. Further, there is a limited amount of area for cooling boxes within the engine compartment which inherently limits the amount of cooling that can be provided by such cooling boxes. Thus, there is a need for an improved cooling system for such off-road equipment which provides better cooling, which is easier to clean and which minimizes the amount of debris which enters the engine compartment.

### BRIEF SUMMARY OF THE INVENTION

The present invention provides an off-road vehicle comprising a frame; an engine compartment mounted on the frame; an engine mounted on the frame within the engine compartment; a cooling assembly mounted on the frame and including a source of liquid and a cooling location disposed external to the engine compartment; wherein the liquid is movable from the source to the cooling location for cooling of the liquid at the cooling location.

### BRIEF DESCRIPTION OF THE SEVERAL VIEWS OF THE DRAWINGS

FIG. 1 is a side elevational view of the off-road vehicle of the present invention.

FIG. 2 is a sectional view of the upper portion of the vehicle showing the fan and cooling boxes within a housing separate from the engine compartment.

FIG. 3 is a sectional view of the housing from above showing the fan and cooling boxes disposed within the housing.

FIG. 4 is a sectional view looking rearward and showing the engine compartment and the elevated housing with the cooling boxes therein.

Similar numbers refer to similar parts throughout the drawings.

### DETAILED DESCRIPTION OF THE INVENTION

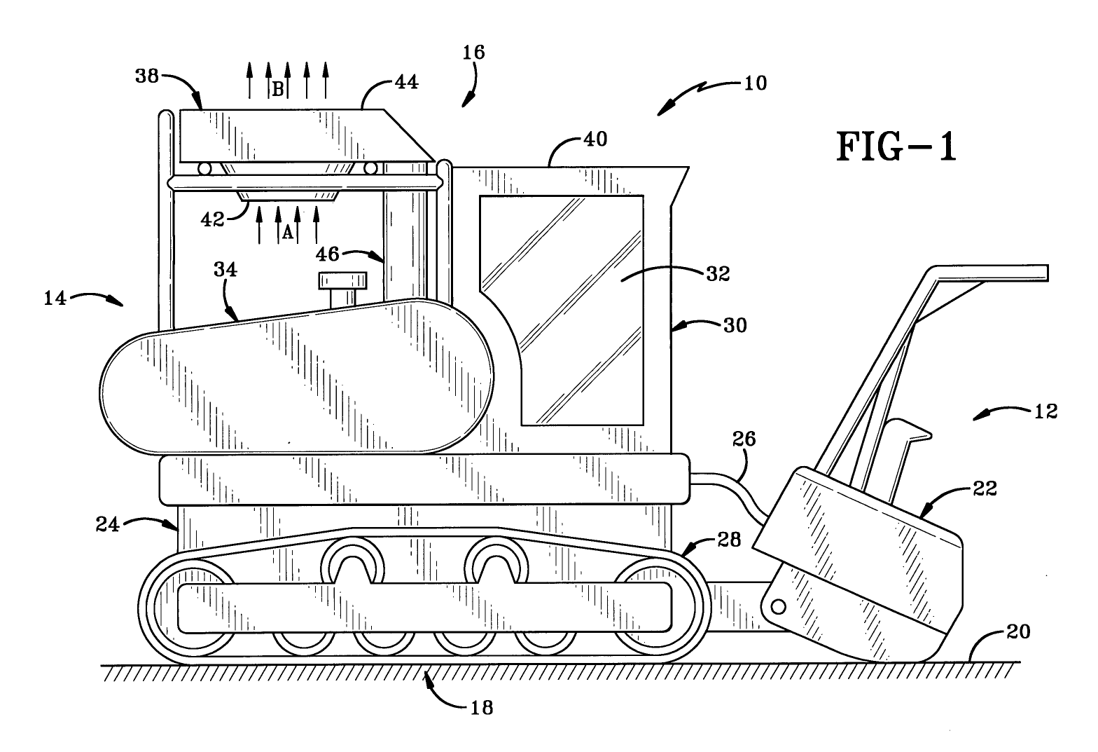

The vehicle and cooling system of the present invention is indicated generally at 10 in FIG. 1. Vehicle 10 is in particular a forestry tool, although vehicle 10 represents off-road equipment in general. Vehicle 10 has a front 12, a rear 14, a top 16 and a bottom 18 which is seated on and runs along a supporting surface 20 which is typically the ground or earth. Vehicle 10 includes a work assembly 22 which during operation engages surface 20 and stirs up dust and various debris which rises into the surrounding air. Work assembly 22 is configured to remove trees and shrubbery from surface 20 and also grind up the wood of such trees and shrubbery as vehicle 10 moves along surface 20. Other off-road equipment represented by vehicle 10 may include alternate work assemblies which perform other types of off-road work.

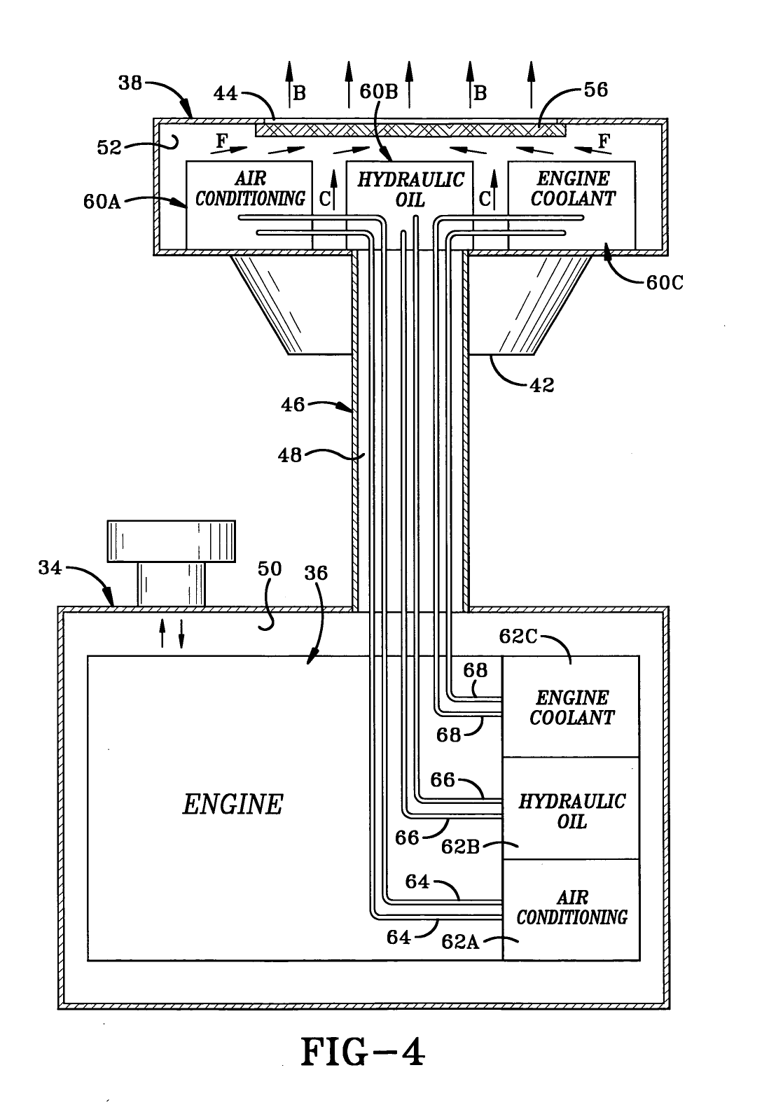

Vehicle 10 includes a frame 24 on which work assembly 22 is movably mounted and from which work assembly 22 extends outwardly in a forward direction. Assembly 22 is hydraulically operated via hydraulic lines 26. Tracks 28 (only one shown) are mounted on frame 24 and revolve in a standard manner to move vehicle 10 along surface 20. An operator's cab 30 is mounted on frame 24 at the front end thereof and includes at least one window 32 to allow the operator to view work assembly 22 and so forth. Preferably, cab 30 is an air-conditioned cab and is thus substantially sealed from the external environment when the door thereof (not shown) is closed. An engine compartment 34 is mounted on frame 24 about midway between top 16 and bottom 18 behind cab 30 and houses an engine 36 (FIG. 4) which is mounted on frame 24 for powering the various aspects of vehicle 10, such as tracks 28, work assembly 22 and so forth.

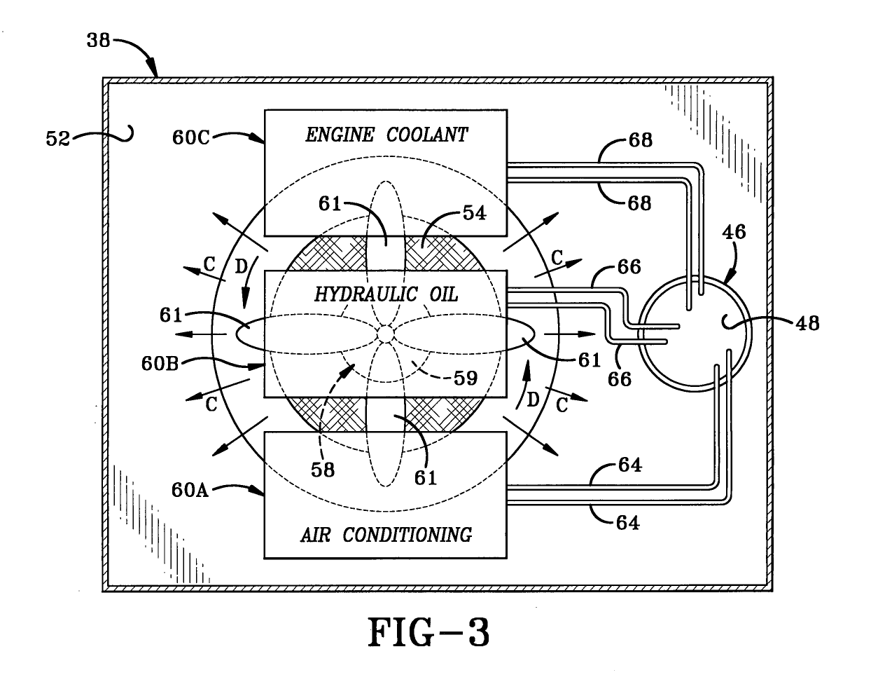

An elevated cooling housing 38 is mounted on frame 24 behind cab 30 at or adjacent top 16 and includes a portion which is the same height as an upper end or top 40 of cab 30. Housing 38 is spaced upwardly from and distal compartment 34. Housing 38 defines a downwardly opening air intake 42 and an upwardly opening exhaust port 44 disposed directly above intake 42. Each of intake 42 and port 44 is open to the external atmosphere or air surrounding vehicle 10. A pipe 46 extends upwardly from compartment 34 to a forward portion of housing 38 and defines a passage 48 (FIG. 4) which communicates with an interior chamber 50 of engine compartment 34 and an interior chamber 52 of housing 38. An intake filter 54 is disposed adjacent intake 42 and an exhaust filter 56 is disposed adjacent exhaust port 44. A fan 58 is disposed within interior chamber 52 of housing 38, as are several heat exchangers or cooling boxes 60. More particularly, these cooling boxes are disposed at a cooling location and include an air-conditioning coolant box 60A, a hydraulic oil box 60B and an engine coolant box 60C (FIGS. 3-4). Fan 58 is typically an electrical fan having an electrical motor 59 and fan blades 61. Motor 59 is in electrical communication with the electrical system of engine 36 and is powered thereby. The cooling system further includes a source 62A of air-conditioning coolant, a source 62B of hydraulic oil and a source 62C of engine coolant (FIGS. 3-4). Source 62A is in fluid communication with cooling box 60A via feed and return lines or conduits 64. Likewise, source 62B is in fluid communication with cooling box 60B via feed and return lines or conduits 66 and source 62C is in fluid communication with box 60C via feed and return lines or conduits 68. Each of sources 62 includes a pump powered by engine 36 for pumping the respective fluid through the respective conduits to the respective boxes 60 and back in a recirculating manner. Conduits 64, 66 and 68 all pass from interior chamber 50 through passage 48 into interior chamber 52.

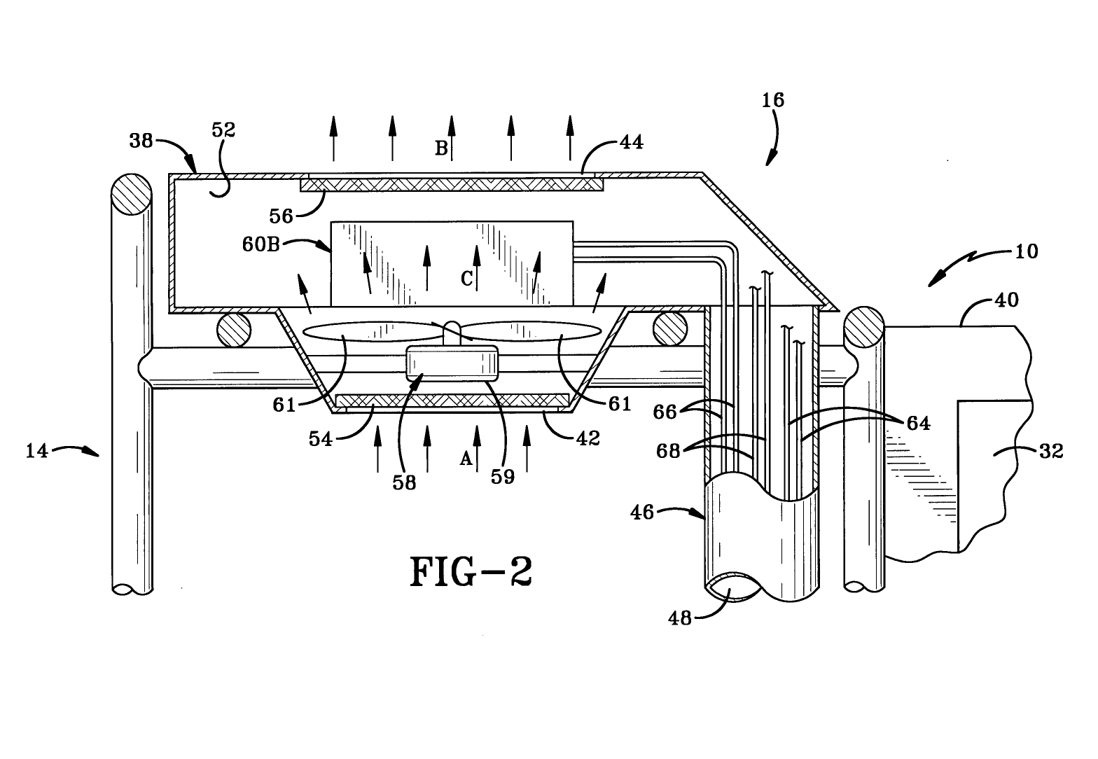

In operation, engine 36 is operated to drive the various moving parts of vehicle 10. More particularly, engine 36 drives tracks 28 in order to move vehicle 10 and drive the operation of work assembly 22 in order to perform the designated off-road work as previously mentioned. In order to provide cooling of the various liquids, engine 36 provides electrical power or the like in order to operate fan 58 so that air is drawn into intake 42 as indicated at arrows A in FIGS. 1 and 2 and exhausted from exhaust port 44 as indicated at arrows B in FIGS. 1, 2 and 4. The elevated nature of housing 38 and intake 42 thereof significantly minimizes the amount of dust and debris which is drawn into the cooling system generally and the separation of housing 38 and compartment 34 substantially eliminates the dust and debris which enters engine compartment 34. It is noted that compartment 34 is ventilated but has a minimal air flow. As air passes through housing 38, it passes around and through boxes 60 as indicated at arrows C in FIGS. 2-4 in order to remove heat from boxes 60, consequently removing heat from the air-conditioning coolant, hydraulic oil and engine coolant flowing respectively through boxes 60A, 60B and 60C. The various fluids which are cooled by this process then return via the respective return lines to sources 62 in order to provide air-conditioning to cab 30, to cool the hydraulic oil used in the various movements of, for instance, tracks 18 and work assembly 22, and to provide cooling to engine 36. The rotation of fan blades 61 is shown at arrows D in FIG. 3 and additional general movement of the air flow through housing 38 is shown at arrows F in FIG. 4.

Thus, the elevated position of housing 38 provides a cooling system in which the amount of dust and debris moving through the intake thereof is substantially minimized. The positioning of fan 58 and cooling boxes 60 external to engine compartment 34 also substantially eliminates the intake of dust and debris into the engine compartment. In addition, creating a separate and enlarged cooling housing, such as housing 38, allows for a substantial increase in the area which can be provided for cooling boxes 60, which are thus preferably enlarged compared to standard cooling boxes in order to provide a larger heat exchange area for more efficient cooling of the various fluids passing therethrough. Further, housing 38 is disposed distal work assembly 22 as far as is feasibly possible in order to minimize the amount of dust and debris entering intake 42. Moreover, the fact that cab 30 is disposed between intake 42 and work assembly 22 also reduces the amount of dust and debris which will enter intake 42. In addition to the substantial reduction of dust and debris entering engine compartment 34, the positioning of housing 38 and the components therein external to compartment 34 make cleaning and maintenance much easier than when such components are disposed within the engine compartment. Thus, the cooling system of vehicle 10 provides a remote cooling package which minimizes the dust and debris which is moved through the cooling system and engine compartment while also providing for a system that is more easily maintained and cleaned.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An off-road vehicle comprising:
a frame;
an engine compartment mounted on the frame;
an engine mounted on the frame within the engine compartment;
a cooling assembly mounted on the frame and including a source of liquid and a cooling location disposed external to the engine compartment; wherein the liquid is movable from the source to the cooling location for cooling of the liquid at the cooling location.

2. The vehicle of claim 1 wherein the frame has an upper end; and wherein the cooling location is disposed adjacent the upper end of the frame.

3. The vehicle of claim 1 wherein the cooling location is distal the engine compartment.

4. The vehicle of claim 3 wherein the cooling location is disposed higher than the engine compartment.

5. The vehicle of claim 1 wherein the cooling assembly includes a heat exchanger which is disposed at the cooling location.

6. The vehicle of claim 5 wherein the frame has an upper end; and wherein the heat exchanger is mounted on the frame adjacent the upper end thereof.

7. The vehicle of claim 5 further including an operator cab mounted on the frame and having an upper end; and wherein the heat exchanger is disposed adjacent the upper end of the cab.

8. The vehicle of claim 5 wherein the cooling assembly includes at least one conduit in fluid communication with the heat exchanger and the source of fluid.

9. The vehicle of claim 8 wherein a portion of the at least one conduit is disposed within the engine compartment.

10. The vehicle of claim 8 wherein the fluid is one of engine coolant, hydraulic oil and air conditioning coolant.

11. The vehicle of claim 8 wherein the cooling assembly further includes a housing; and wherein the heat exchanger is disposed within the housing.

12. The vehicle of claim 11 wherein the cooling assembly further includes a fan; and wherein the fan is disposed within the housing adjacent the heat exchanger.

13. The vehicle of claim 1 wherein the cooling assembly includes a fan disposed external to the engine compartment.

14. The vehicle of claim 13 wherein the frame has an upper end; and wherein the fan is mounted on the frame adjacent the upper end thereof.

15. The vehicle of claim 14 wherein the cooling assembly includes a housing in which the fan is disposed; and wherein the housing defines an air intake which is disposed adjacent the upper end of the frame.

16. The vehicle of claim 13 further including a work assembly mounted on the frame and powered by the engine for performing off road work; and wherein the fan is disposed distal the work assembly.

17. The vehicle of claim 16 further including an operator cab mounted on the frame intermediate the fan and the work assembly.

18. The vehicle of claim 17 wherein the cooling assembly includes a housing in which the fan is disposed; wherein the operator cab has an upper end; and wherein the upper end of the cab and a portion of the housing are disposed at the same height.

19. The vehicle of claim 16 wherein the vehicle has a front and a rear; and wherein the work assembly is disposed adjacent the front of the vehicle and the fan is disposed adjacent the rear of the vehicle.

20. The vehicle of claim 19 wherein the frame has a front and a rear; and wherein the work assembly is movably connected to the frame and extends forward from the front of the frame.
